(19) United States
(12) Patent Application Publication
(10) Pub. No.: US 2018/0211468 A1
(43) Pub. Date: Jul. 26, 2018

(54) AUTOMATIC TELLER MACHINE

(71) Applicant: HITACHI-OMRON TERMINAL SOLUTIONS, CORP., Tokyo (JP)

(72) Inventors: Masaharu TESHIMA, Tokyo (JP); Yasunari NIIOKA, Tokyo (JP)

(73) Assignee: HITACHI-OMRON TERMINAL SOLUTIONS, CORP., Tokyo (JP)

(21) Appl. No.: 15/744,639

(22) PCT Filed: Sep. 16, 2016
(86) PCT No.: PCT/JP2016/077356

§ 371 Date: Jan. 12, 2018

(30) Foreign Application Priority Data
Nov. 30, 2015 (JP) 2015-232601

(51) Int. Cl. G07D 11/00

(52) U.S. Cl. CPC G07D 11/0081; G07D 11/006; G07D 11/0012; G07D 11/0018; G07D 11/0021

(57) ABSTRACT

The purpose of the present invention is to reduce the size of an automatic teller machine (ATM), in which the height of a banknote deposit/withdrawal opening is in a lower position, while maintaining banknote storage capacity. A banknote handling device handles bank notes, and the banknote handling device has a first conveyance roller that conveys bank notes and that changes the conveyance direction of the banknotes between a conveyance path in which the banknotes are conveyed from the deposit/withdrawal unit along the vertical direction and a conveyance path in which the banknotes are conveyed in the horizontal direction. The distance between a delivery unit and a first conveyance unit is shorter than the length of the banknotes in the conveyance direction. Due to this configuration, it is possible to reduce the height of the banknote handling device and to reduce the size of the banknote handling device or the ATM.

### TECHNICAL FIELD

The present invention relates to an automatic teller machine which is installed in financial institutions, such as banks and the like, general shops around towns, and the like, to allow users to perform financial transactions such as banknote deposit, withdrawal, remittance and the like, or relates to a banknote handling device in the automatic teller machine.

### BACKGROUND ART

In recent years, an automated teller machine (hereinafter referred to as “ATM”) has become increasingly installed in various places, such as various kinds of shops including convenience stores, and the like, for the purpose of enhancing convenience for users. In some cases, depending on the installation place, plenty of space for installing an ATM of a conventional size cannot be secured. Therefore, a small-sized ATM reduced in functions and banknote storage capacity as compared with an ATM installed in a bank has been also developed.

However, depending on the region where the ATM is installed, withdrawal transactions may constitute the majority of transactions. In such cases, a conventional small-sized ATM with reduced banknote storage capacity is in need of an increase of the frequency of refilling banknotes, resulting in increase in maintenance costs. On this account, there is an even more increasing need for an ATM being reduced in overall size as well as being provided with adequate banknote storage capacity.

Addressing such needs for size reduction, a technology is known to simplify the conveyance path arrangement by use of a conveyance path which connects between a temporary storage unit and a discrimination unit of the banknote handling device which is a primary unit of ATM, as a bidirectional conveyance path for conveyance of banknotes in both directions (Japanese Patent Application Laid-Open No. 2000-172946).

### CITATION LIST

### Patent Literature

PTL 1: Japanese Patent Application Laid-Open No. 2012-160061

### SUMMARY OF INVENTION

### Technical Problem

However, in conventional techniques, it is difficult to provide an automatic teller machine providing good usability for a wide variety of users due to a high height from the ground of a deposit/withdrawal opening of the banknote handling device.

The present invention is an invention having been made to solve at least part of the above-described conventional problems, and an object of the present invention is to reduce the size of an automatic teller machine or a banknote handling device. In particular, an object of the present invention is to place the banknote deposit/withdrawal opening in a lower vertical position while keeping the banknote storage capacity.

### Solution to Problem

To achieve the above object, a banknote handling device or an automatic teller machine according to the present invention has: a deposit/withdrawal opening for receiving insertion of banknotes from a user or for supplying banknotes to the user; a deposit/withdrawal unit having a delivery unit that delivers banknotes one by one from the deposit/withdrawal opening, and a stacking unit that stacks banknotes one by one into the deposit/withdrawal opening; a first conveyance path along which a banknote is conveyed between the delivery unit and a discrimination unit that performance discrimination on a banknote; a second conveyance path along which a banknote is conveyed between the discrimination unit and a first switching unit that switches a direction of banknote conveyance between a direction toward a temporary storage unit that stores temporarily banknotes and a direction toward the stacking unit; a third conveyance path along which a banknote is conveyed between the first switching unit and the stacking unit; and a first conveying roller that forms part of the first conveyance path and changes a conveyance direction of a banknote conveyed from the delivery unit, from a downward direction to a lateral direction, wherein the first conveying roller comes into contact with a banknote at the time when the delivery unit is in contact with the banknote.

### Advantageous Effects of Invention

According to the present invention, a reduction in size of an automatic teller machine or a banknote handling device becomes possible. Further, it is possible to provide the automatic teller machine or the banknote handling device that is enhanced in usability for a wide variety of users.

### BRIEF DESCRIPTION OF DRAWINGS

FIG. 1 is a front view of ATM.

FIG. 2 is a perspective side view of the ATM.

FIG. 3 is a front view of the interior of an ATM enclosure.

FIG. 4 is a perspective view of an upper unit and a receipt issuing device which are pulled out from the ATM enclosure.

FIG. 5 is a view illustrating the opening/closing operation of the ATM enclosure.

FIG. 6 is a control block diagram illustrating the control relationship of the ATM.

FIG. 7 is a control block diagram of a banknote handling device.

FIG. 8 is a diagram illustrating the upper unit.

FIG. 9 is a diagram illustrating the receipt issuing device and an auxiliary roller in detail.

FIG. 10 is a diagram illustrating a lower unit.

### DESCRIPTION OF EMBODIMENTS

ATM configuration in accordance with the embodiment will now be described with reference to the drawings.

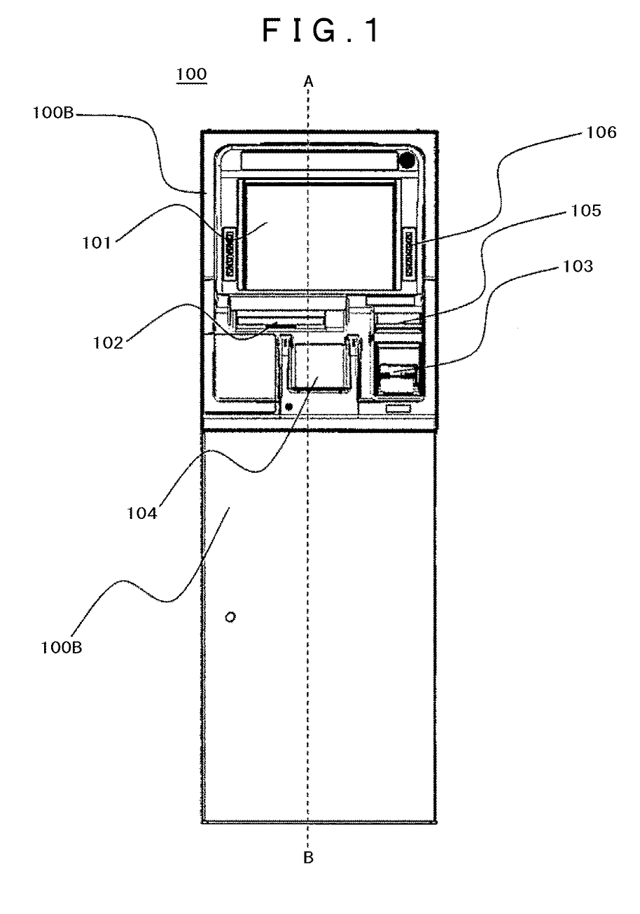

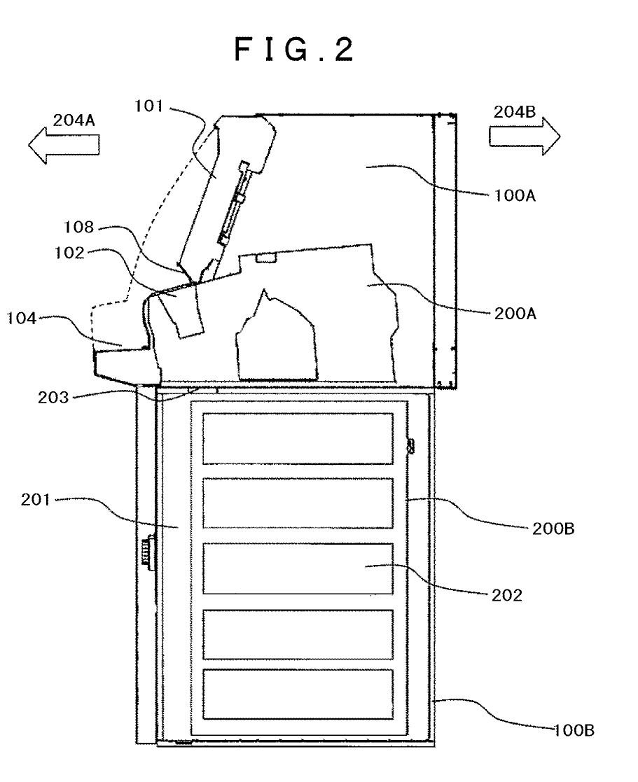

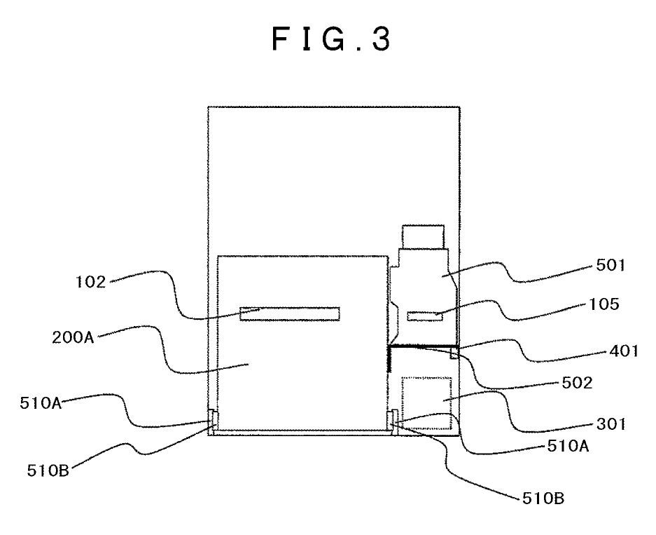

FIG. 1 is a front view of the enclosure of an ATM 100 in accordance with the embodiment. FIG. 2 is a schematically sectional view of the enclosure of the ATM 100 taken along A-B line of FIG. 1. FIG. 3 is a front view of the interior of the enclosure in an upper portion of the ATM 100. The following is a description of FIG. 1 to FIG. 3.

Initially, a description concentrates on FIG. 1. The enclosure of the ATM 100 has an operation unit for interfacing with a customer, such as a display input unit 101, a deposit/withdrawal opening 102, a card handling slot 103, a PIN pad 104, a receipt handling slot 105, and the like.

The display input unit 101 is for giving a user an indication of transaction information which is information on transaction or receiving the transaction operation relating to the transaction from the user. The display input unit 101 may also be for giving a staff an indication of information on maintenance operation or receiving the operation input. The display input unit 101 may include a touch panel or the like.

The deposit/withdrawal opening 102 is for receiving a banknote inserted by the user or supplying a banknote to the user. The PIN pad (PIN: Personal Identification Number) 104 has a plurality of numeric keys (may include a symbol key) for reception of input of information on numerals, such as a secret number or the like, from the user at the time of transaction.

The receipt handling slot 105 is for output of an account statement (receipt) on which transaction details are printed. The card handling slot 103 serves as an insertion slot or a return slot of a card medium handling device that reads information in the card, through which a card insertion is received from the user or through which the card is returned to the user.

Further, function keys 106 are provided on both sides of the display input unit for reception of operation comparable to that on the display input unit 101. The function keys 106 are situated on both sides of the display input unit 101 and in a location at or lower than the midpoint of the height of the display input unit 101, so that a reduction in height of the function key 106 is made possible, enabling maintenance of usability for a wide variety of users.

Next, the arrangement of individual units within the ATM enclosure will be described using FIG. 2 and FIG. 3. The enclosure of the ATM 100 has an upper enclosure 100A and a lower enclosure 100B. The upper enclosure 100A includes an upper unit 200A of a banknote handling device, a receipt issuing device 501 and a card handling device 301. The lower enclosure 100B includes: storage cassettes 202 housing banknotes; a lower unit 200B of the banknote handling device housing the storage cassettes; and a safe 201 which is stronger than the lower enclosure 100B, the safe 201 housing the lower unit 200B of the banknote handling device 200. The safe 201 is more robustly constructed than the enclosure, and the door of the safe 201 is configured to be opened/closed by a key, achieving a higher level of security.

As apparent from FIG. 1 and FIG. 2, the deposit/withdrawal opening 102 for banknotes is place on the left side directly below the display input unit 101. The PIN pad 104 is placed directly below the deposit/withdrawal opening 102 for banknotes and in an approximately central area in a lateral direction of the ATM 100. Also, the receipt handling slot 105 is placed on the right side directly below the display input unit 101, and the card handling slot 103 is placed directly below the receipt handling slot 105. In this manner, the individual processing sections may be placed to be around the center of the upper portion of the ATM 100 to achieve a reduction in size.

The unit arrangement offering reduced size will be described in more detail with reference to FIG. 2. A front end 108 of the display input unit 101 protrudes to above the banknote deposit/withdrawal opening 102 (put another way, a portion (particularly the front end) of the display input unit 101 is situated to overlap the deposit/withdrawal opening 102 in the vertical direction), so that the display input unit 101 is located on the machine front side (placed close to the user), enabling a reduction in size of the ATM 100. Here, the embodiment is described “204A” side indicating the machine front side (forward) and “204B” side referring to the machine rear side (rearward). Also, in the description, words “left” and “right” refer to directions when the machine is viewed from the 204A side.

Such configuration of the display input unit 101 and the banknote handling device 200 enables placing the display input unit 101 and the deposit/withdrawal opening 102 within a predetermined distance from the front of the ATM, the display input unit 101 and the deposit/withdrawal opening 102 being used during operation by the user. This makes it possible to ensure usability for a wide variety of users.

Further, the unit arrangement offering reduced size will be described in more detail with reference to FIG. 3. The receipt issuing device 501 that issues a receipt is placed in a position horizontally overlapping the banknote handling device 200 that conveys media, whereby the receipt handling slot 105 of the receipt issuing device 501 is able to be placed within a predetermined height above the ground. Specifically explaining, the upper unit 200A has a conveyance path along which a banknote is conveyed toward the rear of the upper unit 200A, and also the receipt issuing device 501 stores receipts to be issued (e.g., holding them in a roll form), so that it is difficult to arrange the upper unit 200A and the receipt issuing device 501 in the front-rear direction. In contrast, if the receipt issuing device 501 is placed above the upper unit 200A, this results in the receipt handling slot 105 of the receipt issuing device 501 being at a higher height, causing a reduction in usability for users. Hence, the receipt issuing device 501 and the banknote handling device involving conveyance of media are arranged to overlap each other in the horizontal direction (in the lateral direction as viewed from the front of the machine) as described above, thereby enabling maintenance of usability.

Further, the card handling device 301 handling a card is placed downward of the receipt issuing device 501 in the banknote handling device 200, whereby the card handling slot 103 of the card handling device 301 is able to be placed within a predetermined height above the ground.

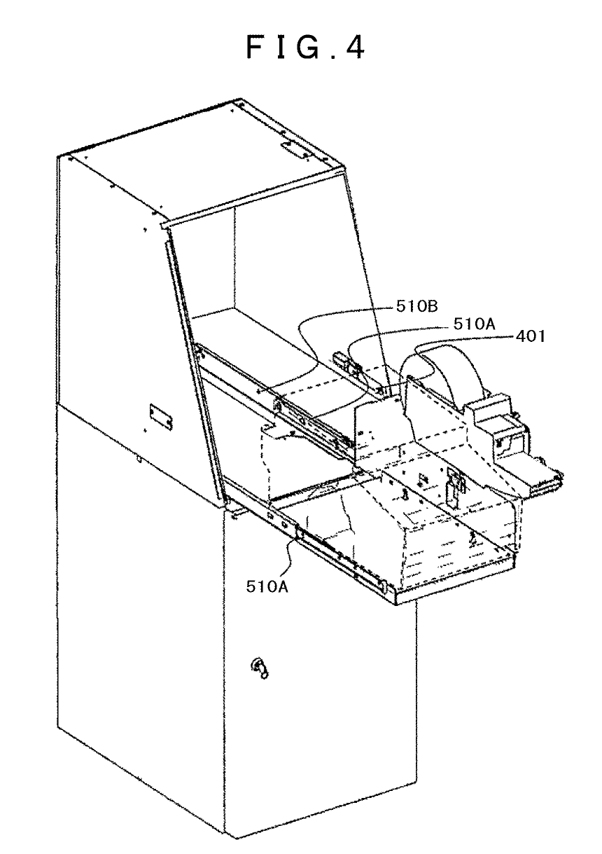

FIG. 4 is a perspective view of the upper unit 200A pulled out from the enclosure 100A. The pull out structure of the upper unit 200A will be described using FIG. 3 and FIG. 4. Incidentally, in FIG. 4, the banknote handling device 200 is shown transparently by the dotted line.

The upper unit 200A of the banknote handling device 200 and the receipt issuing device 501 are incorporated in an upper portion of the machine enclosure. The receipt issuing device 501 is placed on a lateral side (the right side as viewed from the front of the machine) of the upper unit 200A. A right-side wall face of the upper unit 200A of the banknote handling device 200 is secured directly to a left-side wall face of the receipt issuing device 501 with a bolt, a screw and/or the like. Also, the right-side wall face of the upper unit 200A may be connected and secured to a mount plate (also called “mechanical base”) 502 on which the receipt issuing device 501 is mounted, with a bolt, a screw and/or the like, and the receipt issuing device 501 may be connected and secured to the top surface of the mount plate 502 with a bolt, a screw and/or the like. The mount plate 502 is shaped in a recessed form or L-shaped form as viewed from the front of the machine, in which a wall face of the lateral side (one side where it is shaped in a recessed form) is secured to the wall face of the upper unit 200A. That is, the mount plate 502 has a face extending in the vertical direction to be connected to each other, and a face extending in the horizontal direction, in which the face extending in the vertical direction is secured to the wall face of the upper unit 200A, and the receipt issuing device 501 is placed on the face extending in the horizontal direction.

Within the enclosure of the ATM 100, there is a rail 510 sliding (e.g., moving in the front-rear direction), on which the upper unit 200A of the banknote handling device 200 is mounted. A not-sliding, stationary portion 510B of the rail 510 is secured to the interior of the enclosure of the ATM 100. A sliding, slider portion 510A of the rail 510 is secured and connected to the upper unit 200A of the banknote handling device 200. Then, as the slider portion 510A of the rail 510 is slid (moved in the front rear directions or moved out of/back) relative to the stationary portion, the upper unit 200A of the banknote handling device 200 is pulled forward (outward out of the enclosure) or is pushed back into the enclosure from the outside of the enclosure. At this time, the receipt issuing device 501 is secured to the upper unit 200A of the banknote handling device 200, so that the receipt issuing device 501 is also pulled out concurrently with the banknote handling device 200. In this manner, since the receipt issuing device 501 is secured to the banknote handling device 200, a need of a rail used only to pull out the receipt issuing device 501 is eliminated thereby to minimize an increase in breadth of the entire machine, enabling machine downsizing.

More specifically, the slider portion of each rail 510 may be mounted on each of both wall faces of the lateral sides of the upper unit 200A of the banknote handling device 200, and the stationary portion 510B of the rail 510 may be mounted in a sliding position aligned with the slider portion, on a portion of the interior of the enclosure of the ATM 100 above the underside of the upper unit 200A. Then, the receipt issuing device 501 may be connected and secured to the wall face of the lateral side of the upper unit 200A of the banknote handling device 200, above the rail 510 (the receipt issuing device 501 may be secured to the same wall face as the wall face of the banknote handling device 200A on which the slider portion of the rail 510 is secured). Hence, the rail 510 of the upper unit 200A and the receipt issuing device 501 may be arranged to overlap each other in the vertical direction in order to enable minimization of a further increase in breadth of the entire machine.

In this manner, the side portions of the upper unit 200A of the banknote handling device 200 and the receipt issuing device 501 are connected and secured to each other, and then the upper unit 200A alone is mounted to the rails 510 placed within the enclosure, so that the upper unit 200A and receipt issuing device 501 are configured to be pulled out in combination. Because of this configuration, the dimensions in the height direction can be minimized as compared to the case where the devices 200 and 501 are arranged in the vertical direction, and also the dimensions in the lateral direction can be minimized as compared to the case where the devices 200 and 501 are configured to be pulled out on an individual basis. As a result, the entire machine can be achieved to be made compact.

Also, the rail 510 may be secured in a slanting position with the front end of the rail 510 being located more upward than the rear end. Therefore, when the upper unit 200 and the receipt issuing device 501 are pulled out by moving the slider portions 510A of the rails 510, even if the slider portions 510A of the rails 510 are weighted downward with the weight of both the upper unit 200 and the receipt issuing device 501, at the time of opening a door 504 of the lower enclosure 100B, which is a lower portion of the enclosure, placed in front of the lower unit, interference between the rails 510 and the door 504 of the lower enclosure 100B can be suppressed. Furthermore, even when the upper unit 200A is located within the enclosure, the placement is able to be achieved without increasing the distance the door 504 in front of the lower unit 200B and the upper unit 200A.

Also, a panel (the enclosure including the operation unit of ATM) 501 of the upper portion of the machine enclosure of the ATM 100 is opened, and then the upper unit 200A is pulled out of from the machine enclosure. Thereby, the units such as the upper unit 200A, the receipt issuing device 501, and the like can be accessed from above, left and right sides as well as from front, enabling facilitating maintenance. For example, when the upper unit 200A has a paper jam and the receipt issuing device 501 is replenished with a medium, the maintenance efficiency is able to be increased.

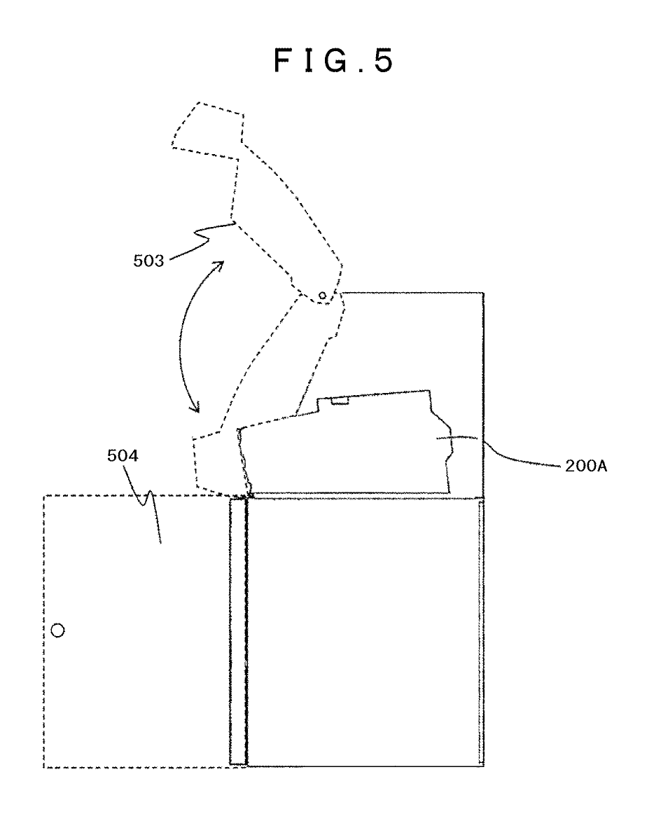

Next, an auxiliary roller 401 illustrated in FIG. 4, FIG. 5 and FIG. 9 will be described. The rotatable auxiliary roller 401 is mounted on the right wall face of the interior of the enclosure. The auxiliary roller 401 is mounted in a position where the auxiliary roller 401 comes into contact with the mount plate (where the auxiliary roller 401 supports the receipt issuing device 501 from below) when the mount plate 502 or the receipt issuing device 501 is housed in the machine. That is, when the mount plate 502 is located within the enclosure, the left side of the mount plate 502 as viewed from the front of the machine is coupled to the upper unit 200A of the banknote handling device 200, while the right side of the mount plate 502 is supported by the auxiliary roller 401. The auxiliary roller 401 may be located in the front of the ATM enclosure. In other words, when the receipt issuing device 501 is housed in the enclosure, the auxiliary roller 401 may be placed forward of the position of the receipt issuing device 501 where the receipt is stored in a roll form. Alternatively, when the receipt issuing device 501 is housed in the enclosure, the auxiliary roller 401 may be situated downward of the slot of the receipt issuing device 501 from which a receipt is issued. By virtue of the auxiliary roller 401, the mount plate 502 and the receipt issuing device 510 are able to be prevented from being weighted down toward the right as viewed from the front of the machine due to the weight of the receipt issuing device 501. Thus, a receipt ejected from the receipt issuing device 510 cannot jam at a medium slot on the operation panel side. It is noted that, if there is no mount plate 502, the auxiliary roller 401 may be in direct contact with the underside of the receipt issuing device 501 to support the receipt issuing device 501.

Further, if there is a card reader, the card handling device may be configured to be mounted on the openable panel side to eliminate the need for an individual pull out mechanism and/or the like.

Next, FIG. 5 is used to describe the opening/closing operation of the front of the upper enclosure 100A which is the upper portion of the enclosure of the ATM 100, and the front of the lower enclosure 100B which is the lower portion of the enclosure.

In the ATM 100, the upper portion and the lower portion of the enclosure are capable of being opened/closed, so that, when a staff performs maintenance or the like, the staff can open/close separately the upper portion and the lower portion to access each of internally-located units and/or the like. For the upper enclosure 100A, as illustrated in FIG. 5, a panel 504 including the operation unit on the front of the enclosure is raised to be flipped from bottom to up to open upward (rotate). Further, for the lower enclosure 100B, the door 504, which is placed in the front of the lower enclosure, opens (rotates) in the lateral direction by being unlocked with a key.

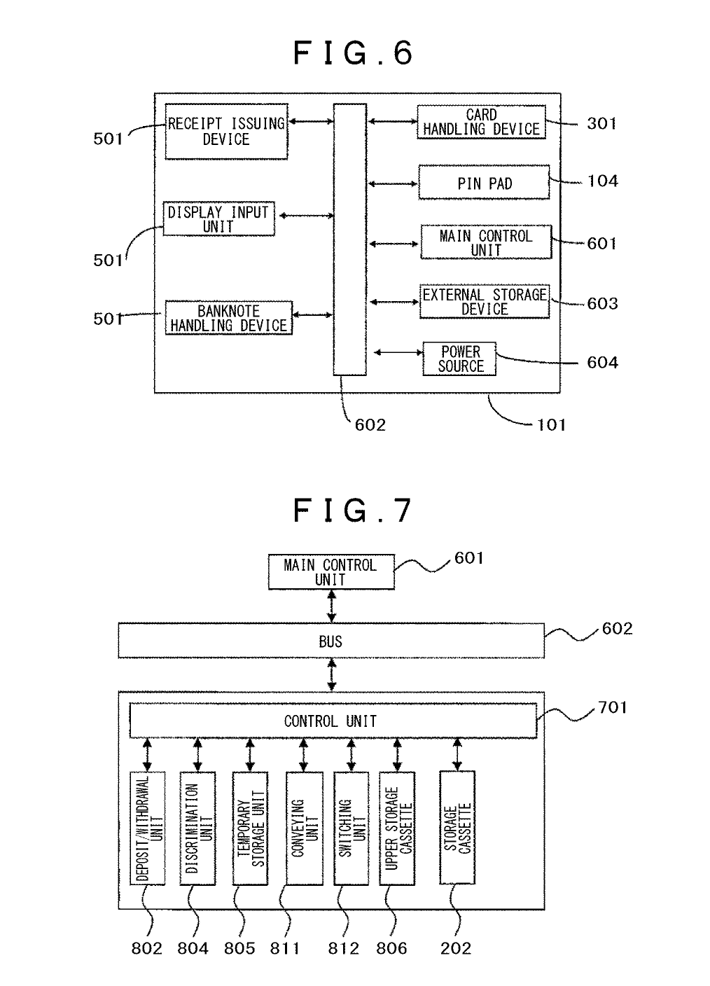

FIG. 6 is a control block diagram illustrating the control relationship of the machine. The card handling device 301, receipt issuing device 501 and the banknote handling device 200, which are housed within the ATM 100, as well as the display input unit 101 and the PIN pad 104 are connected to a main control unit 601 through a bus 602, which performs required operations under the control of the main control unit 601. The main control unit 601 may be connected through the bus 602 to an external storage device 603, in addition to the above, for exchange of necessary data, which is unrelated directly to the features of the present invention and the details are omitted. Note that reference sign 604 shown in FIG. 6 denotes a power source for supplying electric power to each of the above mechanisms and each of the above components.

FIG. 7 is a control block diagram illustrating the control relationship of the banknote handling device 200. A control unit 701 of the banknote handling device 200 is connected through the bus 602 to the main control unit 601 of the ATM 100. Based on the control of the main control unit 601, the control unit 701 controls a deposit/withdrawal unit 802, a discrimination unit 804, a temporary storage unit 805, a conveying/switching unit (811, 812), an upper storage cassette 806 and the storage cassettes 202 of the banknote handling device 100 in order to perform processing pertaining to banknotes.

The main control unit 601 and the control unit 701 may include, for example, a processor, a memory and/or the like.

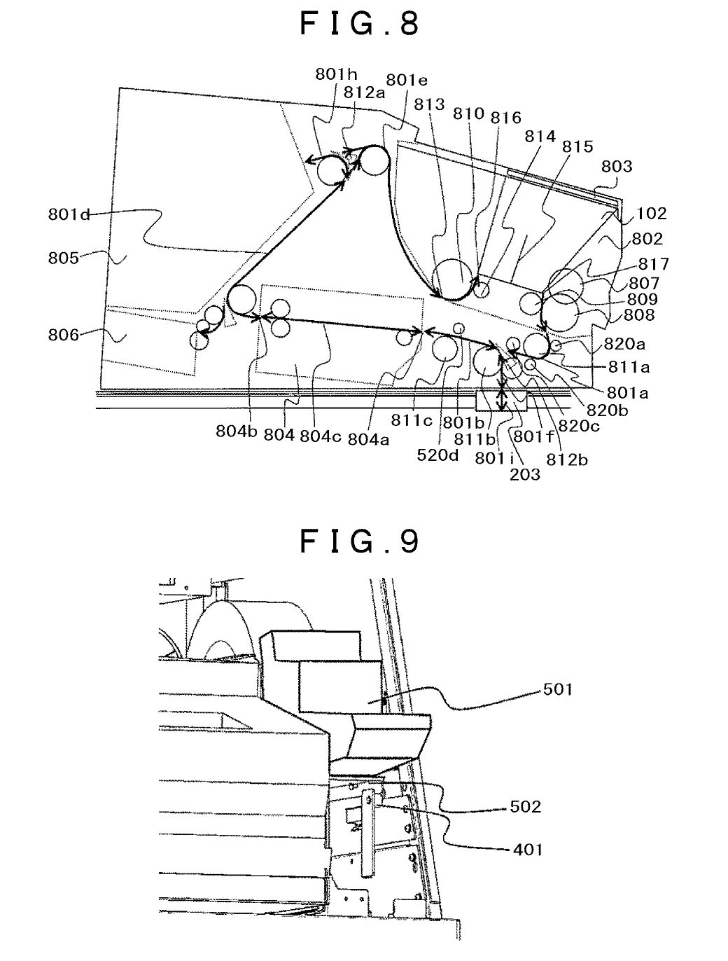

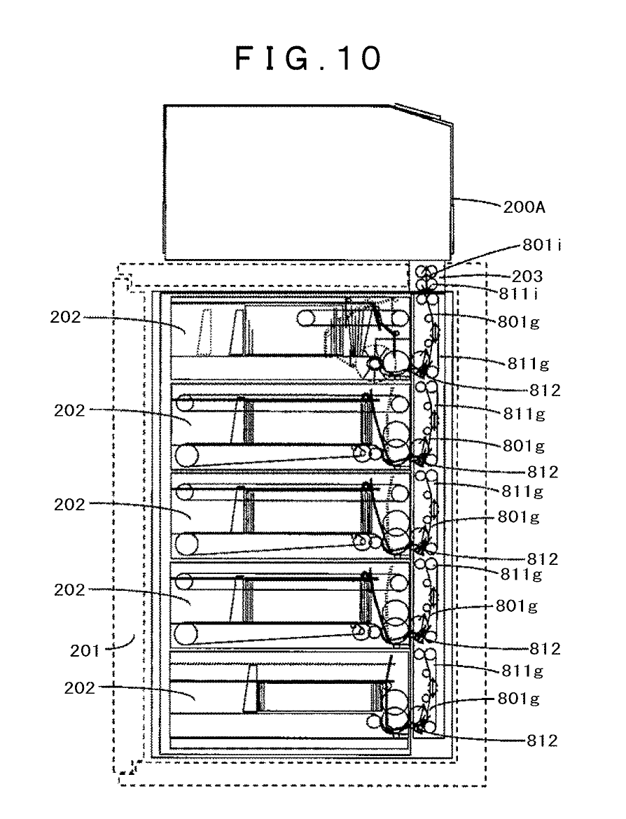

Next, the banknote handling device 200 in accordance with the embodiment will described in detail using FIG. 8 and FIG. 10. The upper unit 200A and the lower unit 200B are described first.

The upper unit 200A is a unit placed in the upper portion of a banknote module 200 (also referred to as the “banknote handling device). The upper unit 200A includes: the deposit/withdrawal opening 102 through which banknotes are received from outside of the machine or banknotes are delivered to outside of the machine; a conveying unit 811 that conveys banknotes; a conveyance path 801 that serves as a passage for banknotes conveyed by the conveying unit 811; and the discrimination unit 804 that performs discrimination of banknotes. Preferably, the temporary storage unit 805 and the upper storage cassette 806 may be possessed, the temporary storage unit 805 which temporarily holds banknotes discriminated by the discrimination unit 804 during deposit/withdrawal processing, the upper storage cassette 806 which holds a banknote which has been determined to be a counterfeit note by the discrimination unit 804 or a left-behind banknote which has been left behind at the deposit/withdrawal opening 102 by the user.

The lower unit 200B is a unit placed in the lower portion of the banknote handling device 200. The lower unit 200B includes: the storage cassettes 202 in which banknotes are kept even after the completion of the deposit/withdrawal processing; a conveying unit 811g that conveys a banknote into a storage cassette 202; and a conveyance path 801g that serves as a passage for a banknote conveyed by the conveying unit. As the storage cassettes 202 in the lower unit 200B, a recycle cassette, a dispense reject cassette, a deposit-only cassette, a dispense-only cassette, and/or a loading collection cassette may be included. The lower unit 200B may have a plurality of recycle cassettes on a denomination-by-denomination basis.

The recycle cassette holds the deposited banknotes at a deposit transaction, and delivers the held banknotes at a withdrawal transaction. The recycle cassette includes a banknote stacking mechanism for accumulating banknotes into the recycle cassette and a banknote delivery mechanism for delivering banknotes. The dispense reject cassette holds banknotes which have been determined to be dispense rejects (unfit for re-dispensing to users due to soiling, tearing and/or the like) by the discrimination unit 804. The dispense reject cassette may have only the banknote stacking mechanism for holding banknotes, out of the banknote stacking mechanism and the banknote delivery mechanism. The deposit-only cassette only holds the deposited banknote and does not deliver a banknote at the withdrawal transaction. The deposit-only cassette may have only the banknote stacking mechanism for stacking banknotes, out of the banknote stacking mechanism and the banknote delivery mechanism. The dispense-only cassette only delivers the banknotes held in the dispense-only cassette, and does not accumulates banknotes at the deposit transaction. The dispense-only cassette may have only the banknote delivery mechanism for delivering banknotes, out of the banknote stacking mechanism and the banknote delivery mechanism. The loading collection cassette loads banknotes into another storage cassette or collects banknotes from another storage cassette. The loading collection cassette may include the banknote stacking mechanism and the banknote delivery mechanism.

Further, for the storage cassette 202, a horizontal type cassette in which banknotes are held in erect position may be employed or a vertical type cassette in which banknotes are stacked in the vertical direction may be employed. In the embodiment, the horizontal type cassette is employed to reduce the dimensions in the depth direction of the machine as compared to the vertical type cassette. Where an increase in the number of storage cassettes is required such as for handling various denominations of banknotes, the vertical cassette may be employed. Using the vertical cassette enables increasing the number of storage cassettes in the lower unit 200B while maintain the height of the upper unit 200A.

Next, the deposit/withdrawal unit 802 included in the upper unit 200A will be described. The deposit/withdrawal unit 802 includes: the deposit/withdrawal opening 102 which is a space for reception of banknotes inserted by the user or for stacking of banknotes to be supplied to the user; a delivery unit (807 to 809) to deliver a banknote from the deposit/withdrawal opening 102; and a stacking unit (810, 814) to stack banknotes in the deposit/withdrawal opening 102. The deposit/withdrawal opening 102 may be configured to have an opening provided on the top, in order to receive banknotes inserted by the user or to stack banknotes to be supplied to the user such that the side face of the banknote comes into contact with the wall face of the front side of the sloped deposit/withdrawal opening 102. The banknote handling device 200 or the ATM 100 may have a shutter 803 covering the deposit/withdrawal opening. The shutter 803 may be configured to open when banknotes are supplied from the deposit/withdrawal opening 102 to the user or when banknotes are received at the deposit/withdrawal opening from the user.

The deposit/withdrawal opening 102 includes a delivery slot 817 in a lower portion of the deposit/withdrawal opening 102, through which a banknote passes when the banknote is delivered from the deposit/withdrawal opening 102 into the banknote handling device 200. Further, the deposit/withdrawal unit may include a pressing plate 815 to press banknotes inserted by the user against the wall face on the machine front side. The deposit/withdrawal unit 802 includes the delivery unit (e.g., a pickup roller and a feed roller located below it) provided on the machine front side of the deposit/withdrawal opening 102. A pickup roller 807 of the delivery unit comes into contact with a banknote pressed against the wall face of the front side of the deposit/withdrawal opening 102 by the pressing plate 815, in order to separate the banknotes individually, and then the pickup roller 807 cooperates the feed roller 808 to convey the banknote from the delivery slot into the conveyance path. Further, the delivery unit 802 may have a gate roller 809 to prevent simultaneous delivery of two or more banknotes at one time, and the feed roller 808 may face the gate roller 809. The feed roller 808 and the gate roller 809 form part of the conveyance path within the deposit/withdrawal opening 102.

The deposit/withdrawal opening 102 includes a stacking slot 816 in a lower portion of the deposit/withdrawal opening 102, through which a banknote passes when the banknotes are carried one by one from within the banknote handling device 200 into the deposit/withdrawal opening 102 to be stacked. The deposit/withdrawal unit 102 includes a stacking unit (810, 814) below the stacking slot 816. The stacking roller 810 delivers a banknote from the conveyance path into the stacking slot 816. A vane roller 814 stacks the delivered banknote on a banknote within the deposit/withdrawal opening 102. The stacking unit (810, 814) may have two opposed shafts in the deposit/withdrawal unit 802, and have the rollers (810, 814) on the respective shafts to form part of the conveyance path within the deposit/withdrawal unit 102.

The banknote handling device 200 includes a drive source to drive the delivery unit (807 to 809) and the stacking portion (810, 814) of the deposit/withdrawal unit 802. Examples of the drive source include a motor and the like. Further, the deposit/withdrawal unit 802 may be unitized. Unitization will be described later.

Note that the deposit/withdrawal opening 102 may be configured to be separated into a deposit opening for receiving banknotes inserted by the user and a withdrawal opening for stacking banknotes to be supplied to the user. Further, the upper unit 100A may include a foreign-substance storage space for housing foreign substances, between the bottom of the deposit/withdrawal opening and a first conveyance path 801a, b. In the bottom of the deposit/withdrawal opening, there is a slit through which the foreign substance which has been inserted into the deposit/withdrawal opening is dropped into the foreign-substance storage space, so that the foreign substance passes through the slit in question to be housed in the foreign-substance storage space. The foreign substance housed in the foreign-substance storage space may pass through a passage which extends from the foreign-substance storage space to the outside of the ATM enclosure, and then may be returned to a foreign-substance return slot from which the user takes the foreign substance.

Next, the temporary storage unit 805 included in the upper unit 200A will be described. The temporary storage unit 805 temporarily stores banknotes. More specifically, banknotes are temporarily stored when deposit counting is performed to count the banknotes on the basis of the discrimination result of the discrimination unit 804, and all the banknotes stored in the temporary storage unit 805 are delivered one by one when the deposit storing process is performed to store the banknotes in the storage cassette 202 or the deposit/withdrawal opening 102. Further, when dispense processing is performed to dispense banknotes from the storage cassette 202, the temporary storage unit 805 may temporarily hold a banknote which has been determined to be a dispense-rejected banknote based on the discrimination result of the discrimination unit 804. After the banknotes corresponding to the amount of money to be dispensed are delivered into the deposit/withdrawal opening 102, all the banknotes stored in the temporary storage unit 805 may be kept in the upper storage cassette 806 or the dispense reject cassette 202.

The temporary storage unit 805 may be of a reeling type in which banknotes are reeled for storage or may be of a stack type in which banknotes are stacked for storage.

Next, the conveying unit 811, which conveys a banknote in the upper unit 200A and the lower unit 200B, will be described.

Banknotes are conveyed by the conveying unit. Examples as the conveying unit 811 include a conveying belt, a conveying roller and/or the like. The conveyance path 801 is a passage along which the conveying unit 811 conveys banknotes. The conveyance path 801 may be formed with a driven component 820 (e.g., driven roller) and a conveyance guide which guides a portion of the conveying unit 811 coming into contact with a banknote and guides conveyance of a banknote. The conveying unit 811 may convey banknotes in only one direction, or may convey banknotes in both directions. The banknote handling device 200 includes a drive source to driving the conveying unit 801 in one direction or both directions. The conveying unit 801 may be driven by the drive source to convey banknotes. As the drive source, there is a motor and/or the like.

Further, the switching unit 812 switches the direction of banknote conveyance in order to select the conveyance path 801 along which banknotes are conveyed. The control unit performs switching control on the switching unit 812 on the basis of a discrimination result, a kind of transaction, a kind of processing or he like. The switching unit 812 may be, for example, a switching gate and/or the like. The banknote handling device includes a drive source for driving the switching unit 812. As the drive source, there is a solenoid and/or the like.

Next, the configuration of the upper unit 200 will be described in detail, which is one of the features of the embodiment. In the embodiment, possessed are: a first conveyance path (801a, b) which conveys banknotes (or along which banknotes are conveyed) between the deposit/withdrawal unit (delivery unit 807 to 809) and the discrimination unit 804; a second conveyance path 801d which conveys banknotes (or along which banknotes are conveyed) between the discrimination unit 804 and a first switching unit 812a; and a third conveyance path 801e which conveys banknotes (or along which banknotes are conveyed) between the first switching unit 812a and the deposit/withdrawal unit (the stacking unit 810, 814).

Further, a temporary-vault conveyance path 801h is possessed to convey banknotes between the first switching unit 812a and the temporary storage unit 805. The first switching unit 812a switches the conveyance direction between a direction toward the stacking unit 810, 814 (the third conveyance path 801e) and a direction toward the temporary storage unit 805 (the temporary-vault conveyance path 801h), for the banknotes conveyed from the discrimination unit side of the second conveyance path 801d. Further, for the banknotes conveyed from the temporary storage unit 805 side of the temporary-vault conveyance path 801h, the first switching unit 812a switches the conveyance direction between a direction toward the discrimination unit 804 (the second conveyance path 801d) and a direction toward the stacking unit 810, 814 (the third conveyance path 812e). The first switching unit 812a may be located above the discrimination unit 804.

Further, as illustrated in FIG. 8, the third conveyance path 801e may be configured by diverging the conveyance path to which banknotes are conveyed from the temporary-vault side (the temporary-vault conveyance path 801h) of the first switching unit 812a, and the conveyance path to which banknotes are conveyed from the discrimination unit side (the second conveyance path 801d).

Further, each conveyance path (e.g., a first conveyance path 801a, b, a second conveyance path 801d, a third conveyance path 801e, the temporary-vault conveyance path 801h, a later-described sixth conveyance path 801f, a conveyance path 801g of the lower unit 200B) may be configured include the conveying unit 811 to convey banknotes.

Next, a first conveyance path 801a, b will be described in detail. The first conveyance path 801a, b may be a conveyance path connecting the delivery unit (807 to 809) and the discrimination unit. The first conveyance path 801a, b has a fourth conveyance path 801a and a fifth conveyance path 801b, in which the fourth conveyance path 801a conveys a banknote from the delivery unit (807 to 809) in the downward direction, then changes the direction of banknote conveyance to a horizontal direction along a first conveying roller 811a, and then conveys the banknote to a second switching unit 812b, and the fifth conveyance path 801b conveys the banknote in the horizontal direction between the fourth conveyance path 801a and the discrimination unit.

The fourth conveyance path 801a may be a conveyance path connecting the delivery unit (807 to 809) and the fifth conveyance path 801b, or may be made up of conveyance paths, i.e., a conveyance path connecting the delivery unit (807 to 809) and the first conveying roller 811a, and a conveyance path connecting the first conveying roller and the second switching unit 812b. The fourth conveyance path 801a may be made up of conveyance paths, i.e., a conveyance path extending from the delivery unit (807 to 809) along the vertical direction, and a conveyance path extending through the first conveying roller 811a along the horizontal direction.

The fifth conveyance path 801b may be a conveyance path connecting the fourth conveyance path 801a and the discrimination unit. The fifth conveyance path 801b may be a conveyance path extending along the horizontal direction.

The fourth conveyance path 801a or the fifth conveyance path 801b may be situated below the deposit/withdrawal unit 802 (particularly, the delivery slot 817 and the stacking slot 816). Alternatively, the fourth conveyance path 801a or the fifth conveyance path 801b may be situated between the bottom surface of the upper unit 200A and the bottom surface of the deposit/withdrawal unit 802. The portion of the fourth conveyance path 801a from the first conveying roller 811a to the second switching unit 812 (a conveyance path of the fourth conveyance path 801a for conveyance in the horizontal direction) may be sloped in a direction in which the second-switching-component-812b end is located at a higher level than the first-conveying-roller-811a end (the first-conveying-roller-811a end is located at a lower level than the second-switching-unit-812b end) Further, the fifth conveyance path 801b may be sloped in a direction in which the discrimination-unit-804 end is located at a higher level than the fourth-conveyance-path-801a (second-switching-unit-812b) end (the fourth-conveyance-path-801a end is located at a lower level than the discrimination-unit-804 end).

The first conveying roller 811a end of the fourth conveyance path 801a is placed at a lower level than the second switching unit 812b end or the fourth conveyance path 801a end of the fifth conveyance path 801b is placed at a lower level than the discrimination unit 804 end, thereby making it possible to prevent the deposit/withdrawal unit 802 from being located at a higher height due to the height from the ground of the banknote inlet/outlet of discrimination unit 804, in turn making it possible to place the deposit/withdrawal opening 102 at a lowered height.

Specifically, where the discrimination unit 804 is unitized, in the unitized discrimination unit 804, the height position of a discrimination-unit conveyance path 804c is fixed. Because of this, with reference to the height position of the banknote inlet/outlet of the discrimination 804, the deposit/withdrawal opening 102 may be placed at a higher height. However, as in the embodiment, sloping the fourth conveyance path or fifth conveyance path enables a reduction of the height from the ground of the deposit/withdrawal opening 102 while maintaining a necessary mechanism (e.g., the foreign-substance storage space, the second switching unit and the like) between the bottom surface of the deposit/withdrawal unit 802 and the bottom surface of the upper unit 200A. In particular, tilting the fourth conveyance path 801a enables reducing the height from the ground of the delivery unit side of the deposit/withdrawal opening 102. Tilting the fifth conveyance path 801b enables reducing the height from the ground of the stacking unit side of the deposit/withdrawal opening 102.

Further, as in the embodiment, where the deposit/withdrawal unit is configured to be an integrated unit, sloping the fourth conveying unit and the fifth conveying unit as described above enables a reduction of the height from the ground of the overall deposit/withdrawal opening. It is noted that unitization may mean to be grouped into a cluster distinguishable from another component of the machine or to be grouped as a single cluster to be removed by disengaging members fixed to the banknote handling device.

The conveying unit of a sixth conveyance path 801f conveys a banknote between the fifth conveyance path 801b and a conveyance path 801i for a transfer unit 203. The driven component 820 or the conveying unit 811i on the conveyance path 801i for the transfer unit 203 conveys a banknote between the conveyance path 801g in the lower unit 200B and the sixth conveyance path 801f in the upper unit 200A. The sixth conveyance path 801f may be situated below the fourth conveyance path 801a and the fifth conveyance path 801b. A second switching unit 812b is possessed in a location where the fifth conveyance path 801b and the fourth conveyance path 801a are connected to each other. The second switching unit 812b switches the conveyance direction of a banknote conveyed by the fifth conveyance path 801b, to a direction toward the fourth conveyance path 801a or to a direction toward the sixth conveyance path 801f.

The fourth conveyance path 801a may include the first conveying roller forming part of the fourth conveyance path 801a. The fifth conveyance path 801b or the sixth conveyance path 801f may include a second conveying roller 811b forming part of the fifth conveyance path 801b and the sixth conveyance path 801f. In other words, the second conveying roller 811b is shared between the fifth conveyance path 801b and the sixth conveyance path 801f.

The following is a more detailed description on the first conveyance path (the fourth conveyance path 801a, the fifth conveyance path 801b) and the sixth conveyance path 801f.

Here, the fourth conveyance path 801a may have a first horizontal driven component 820a placed in a position faced toward through the fourth conveyance path 801a, and may have a first vertical driven component 820b placed in a position faced toward the vertical (height) direction. The first horizontal driven component 820a and the first vertical driven component 820b may rotate following the first conveying roller 811a. Also, the first horizontal driven component 820a and the first vertical driven component 820b may have a smaller shaft diameter than that of the first conveying roller 811a.

Further, the first conveying roller 811a and the second conveying roller 811b may be placed in a position where both the rollers 811a, 811b overlap each other in the horizontal direction (or in a position where the first conveying roller 811a and the second conveying roller 811b do not overlap each other in the vertical direction). In particular, where the fifth conveyance path 801b and a conveyance path for conveyance of banknotes in a lateral direction with respect to the fourth conveyance path 801a are sloped as described earlier, the first conveying roller 811a may be possessed in a location above the conveyance path for conveyance of banknotes in a lateral direction with respect to the fourth conveyance path 801a, and the second conveying roller 811b may be possessed in a location below the fifth conveyance path 801b. As a result, it is possible to make effective use of room which is created between the bottom surface of the upper unit 200A and the fifth conveyance path 801b by sloping the fifth conveyance path 801b, and in turn this enables a reduction of the height from the ground of the deposit/withdrawal opening 102.

Further, the first conveying roller 811a will be described in detail. The first conveying roller 811a has a role to change the direction of banknote conveyance from the vertical direction (a direction along the perpendicular direction) to the lateral direction (a direction along the horizontal direction) for a banknote conveyed from the deposit/withdrawal unit 802. In this connection, the direction of banknote conveyance being the vertical (up-down) direction may mean that the conveyance direction is closer to the perpendicular direction rather than the horizontal direction, and the direction of banknote conveyance being the lateral (front-rear) direction may mean that the conveyance direction is closer to the horizontal direction rather than the perpendicular direction. Further, where the direction of banknote conveyance is changed, the angle at which the conveyance direction is turned may be changed to various angles, and preferably, the angle of the conveyance path 801a (the conveyance direction) between the front and the back of the first conveying roller 811a may be an acute angle. Further, the first conveying roller 801a has a role to receive a banknote conveyed by the feed roller 808 of the deliver section (807 to 809). While the dimensions of the banknote handling device in the height direction and in the front-rear direction are reduced, the space in the lower portion of the deposit/withdrawal unit is able to be used effectively.

The first conveying roller 811a may be come into contact with a banknote at the time when the delivery unit (807 to 809) (particularly, the feed roller 808 and the gate roller 809) are in contact with the banknote in question. In other words, before the delivery unit (807 to 809) (particularly, the feed roller 808 and the gate roller 809) comes out of contact with (not support) a banknote, the first conveying roller 811a may come into contact with (support) the banknote in question. That is, the distance between the first conveying roller 811a and the delivery unit (807 to 809) (particularly, a position in contact with the feed roller 808 and the gate roller 809) (e.g., a distance between the rotating shaft of the first conveying roller and the rotating shaft of the feed roller 808) may be shorter than the length in the conveyance direction of a conveyed medium.

By forming the first conveying roller 811a as described above, the first conveying roller 811a is able to fulfill the two roles, the role to receive the banknote conveyed from the deposit/withdrawal unit and the role to change the conveyance direction.

Further, the first conveying roller 811a may be placed immediately below the delivery unit (807 to 809). Further, the first conveying roller 811a may be configured to rotate at the same speed of the delivery unit (807 to 809). That is, a drive unit of the first conveying roller 811a may be shared with the delivery unit (807 to 809) and may be different from that of another conveying unit (e.g., the second conveying roller 811b and a later-described third conveying roller 811c). Alternatively, the drive unit of the first conveying roller 811a may be driven in synchronism with a drive unit of the delivery unit (807 to 809). As a result, the banknote conveyed from the delivery unit (807 to 809) is able to be inhibited from being jammed. More specifically, if the delivery unit is provided with a sensor for detecting the length of a banknote but it is cannot determined from the length whether a single banknote is delivered in the event of delivering two or more banknotes at one time and/or the like, the operation of the delivery unit can be stopped in order to stop the first conveying roller, enabling a reduction in jam occurring in the conveyance path.

Next, the relationship between the third conveyance path 801e and the fifth conveyance path 801b will be described in detail. The third conveyance path 801e may be connected to the first switching unit 812a and the stacking unit (810, 814) (a conveyance path forming part of the stacking unit (810, 814)). The stacking unit (810, 814) conveys a banknote from the front end of the third conveyance path 801e to the stacking slot 816 so that the banknote is stacked in the deposit/withdrawal opening 102. A first lower end 813 is a lowest end of the third conveyance path 801e. At the first lower end 813, the third conveyance path 801e may be connected with the stacking unit (810, 814) or the conveyance path forming part of the stacking unit (810, 814). The first lower end 813 may be situated above the fifth conveyance path 801b (forward of the front side of the discrimination unit 804). This makes it possible to place the deposit/withdrawal unit 802 in a forward area. In turn, by placing the deposit/withdrawal unit 802 in a forward area, for example, the display input unit 101 of the ATM 100 placed above the upper unit 200A is able to be placed in the front of the machine, thus achieving enhanced usability.

Further, the first lower end 813 may be placed downward of the upper face of the discrimination unit 804. This makes it possible to reduce the height from the ground of the deposit/withdrawal unit 802. In this case, the first lower end 813 and the conveying units around the first lower end 813 may possibly restrict the space for placing the conveying unit of the fifth conveyance path 801b.

Even if the first lower end 813 is placed downward of the upper face of the discrimination unit 804 or even if the first lower end 813 is placed above the fifth conveyance path 801b (forward of the front face of the discrimination unit 804), the space for the conveying unit of the fifth conveyance path 801b and/or the foreign-substance storage space for storing a foreign substance (e.g., a coin and the like) inserted into the deposit/withdrawal opening can be ensured by sloping the fifth conveyance path 801b. Further, the third conveying roller 811c (e.g., the third conveying roller), which is the conveying unit of the fifth conveyance path 801b, is placed closer to the discrimination unit 804 (rearward) than the second conveying roller 811b is placed, and this third conveying roller 811c (e.g., the third conveying roller) may be placed below the fifth conveyance path 801b. This makes it possible to ensure the space for the conveying unit of the fifth conveyance path 801b and/or the foreign-substance storage space. The third conveying roller 811c may be a conveying unit located immediately in front of the discrimination unit 804 (closet to the discrimination unit 804) out of the conveying units forming the fifth conveyance path 801b. Further, when a discrimination-unit conveying unit conveying a banknote is in contact with the banknote within the discrimination unit 804, the third conveying roller 811c may be in contact with the banknote in question. Also, the third conveying roller 811c may be placed below the first lower end 813. That is, the distance between the third conveying roller 811c and the discrimination-unit conveying unit (e.g., the distance between the shafts) is shorter than the length in the conveyance direction of the medium conveyed.

Further, the first conveying roller 811a and the third conveying roller 811c may be placed in a position where both the rollers 811a, 811c overlap each other in the horizontal direction (or in a position where the first conveying roller 811a and the third conveying roller 811c do not overlap each other in the vertical direction).

Further, the fifth conveyance path 801b may have a second driven component 820c and a third driven component 820d situated respectively on the opposite sides of the fifth conveyance path 801d from the second conveying roller 811b and the third conveying roller 811c. The first horizontal driven component 820a and the first vertical driven component 820b rotate following the conveyance of a banknote by the first conveying roller 811a. The second driven component 820c and the third driven component 820d rotate following the conveyance of a banknote by the second conveying roller 811b and the third conveying roller 811c, respectively. Further, the first horizontal driven component 820a, first vertical driven component 820b, second driven component 820c and the third driven component 820d may not have a drive source and may rotate upon contact with a banknote conveyed by the conveying unit. More specifically, the driven components 820a to 802d may be driven by objects facing them. Therefore, when there is no banknote, the driven components 820a to 802d may be driven by the conveying units 811a to 811c respectively facing them, and when there is a banknote, the driven components 820a to 802d may be driven by the banknote passing through them.

The first horizontal driven component 820a, first vertical driven component 820b, second driven component 820c and the third driven component 820d may be, for example, a driven roller.

Further, the first horizontal driven component 820a and the first vertical driven component 820b are smaller in shaft diameter (or in a lower height position) than the first conveying roller 811a. The second driven component 820c is lower in shaft diameter (or in a lower height position) than the second conveying roller 811b. The third driven component 820d is smaller in shaft diameter (or in a lower height position) than the third conveying roller 811c. In this case, the first vertical driven component 820b may be placed below the fifth conveyance path 801b, and the first conveying roller 811a may be placed above the fifth conveyance path 801b. Then, the second driven component 820c or the third driven component 820d may be placed above the fifth conveyance path 801b and the second conveying roller 811b or the third conveying roller 811c may be placed below the fifth conveyance path 801b.

Further, the conveying units between the bottom surface of the deposit/withdrawal unit and the bottom surface of the upper unit may be formed entirely of conveying rollers without a conveying belt, thereby enabling minimization of the height from the ground of the deposit/withdrawal unit. Further, in each of sets of the first conveying roller 811a and the second conveying roller 811b and of the second conveying roller 811b and the third conveying roller 811c, the distance between rollers (shaft-to-shaft distance between the rotating shafts of the rollers) may be shorter than the length in the conveyance direction of a conveyed medium which is being conveyed. This makes it possible to simplify the first conveyance path 801a to reduce the height from the ground of the deposit/withdrawal opening 102. In this case, the conveying unit 811 of the first conveyance path 801a may be configured to include only the first conveying roller 811a, the second conveying roller 811b and the third conveying roller 811c. A further reduction in size is made possible.

Further, in the case of use of the conveying roller, a mechanism of passing a belt is unnecessary, so that machine simplification and also a reduction in machine size are made possible. Further, in the case of use of a conveying belt, if replacement is needed due to repair and/or the like, disassembly is typically required all across the range where the belt is placed. This is likely to increase the workload, but in the case of the conveying roller, a reduction in workload is possible.

In contrast, the conveying unit of each conveyance path may include a conveying belt. Forming the conveying unit of the conveying belt enables stable conveyance. Where a conveying belt is wound on the aforementioned first conveying roller 811a, second conveying roller 811b or the third conveying roller 811c, the first conveying roller 811a, the second conveying roller 811b or the third conveying roller 811c will mean a roller that rotates for driving the wound conveying belt.

Next, the discrimination unit 804 will be described. The discrimination unit 804 has a discrimination-unit conveyance path 804c and a discrimination-unit conveying unit to convey banknotes in the discrimination unit 804. The discrimination-unit conveyance path 804c is a passage for banknotes to be conveyed by the discrimination-unit conveying unit. Examples as the discrimination-unit conveying unit include a conveying roller, a conveying belt and/or the like. The discrimination-unit conveyance path 804c and the discrimination-unit conveying unit may convey banknotes in both directions. The first conveyance path (801a, b) and the second conveyance path 801d are connected to the discrimination-unit conveyance path 804c, in which an banknote inlet/outlet of the discrimination unit 804 (discrimination-unit conveyance path 804c) connected to the first conveyance path (801a, b) may be a first inlet/outlet 804a, and another banknote inlet/outlet of the discrimination unit 804 (discrimination-unit conveyance path 804c) connected to the first conveyance path (801a, b) may be a second inlet/outlet 804b. Further, the upper surface of the discrimination unit 804 may be configured to be located at a higher level than the bottom surface of the deposit/withdrawal unit 802. This makes it possible to reduce the height from the ground of the deposit/withdrawal unit 802.

Further, the discrimination unit 804 may be placed such that the discrimination-unit conveyance path 804c is sloped. A fixing component is provided to connect the discrimination unit 804 in an inclined manner to the bottom surface of the upper unit 200A. This makes it possible to reduce the height from the ground of either the first inlet/outlet 804a or the second inlet/outlet 804b of the discrimination unit 804. In particular, by inclining the discrimination unit 804 such that the first inlet/outlet 804a is located at a lower level than the second inlet/outlet 804b, the deposit/withdrawal unit 802 can be inhibited from being located in a higher height position due to the height from the ground of the banknote inlet/outlet of the discrimination unit 804, thus enabling the placement of the deposit/withdrawal opening 102 in a lower height position.

The discrimination unit 804 includes sensors for acquiring necessary information to authenticate a banknote conveyed or to determine a denomination or reject (including the physical quality) of a banknote conveyed (e.g., an image sensor, a thickness sensor, a magnetic sensor and/or the like). Then, the discrimination unit 804 performs discrimination of the banknote for authentication, denominations or reject, based on the acquired information. The control unit determines which destination the banknote should be conveyed to, based on the discrimination result made by the discrimination unit 804, and then the control unit controls the switching unit to switch the direction of banknote conveyance.

Next, the transfer unit 203 will be described. In the embodiment, the transfer unit 203 between the conveyance path of the lower unit 200B and the sixth conveyance path 801f is placed rearward of the first conveying roller 811a. This makes it difficult to make access to the transfer unit 203, enabling enhancement in security. Further, where the lower unit 200B is surrounded with the safe 201 which is stronger than the enclosure, only the transfer unit 203 is a place via which the interior of the safe 201 can be accessed without unlocking the safe 201, and therefore an enhancement of the security of this place is more effective. Further, the security is able to be enhanced by the first conveyance roller 811a curbing access to the transfer unit 203 or the lower unit 200B surrounded with the safe 201.

Further, in the embodiment, a dense construction of the upper unit 200A around the transfer unit 203 is achieved by placing the bottom surface of the deposit/withdrawal unit 802 at a lower level than the upper surface of the discrimination unit 804 (low height arrangement), in order to curb access to the transfer unit 203.

Further, to a conveyance path for conveying banknotes to the lower unit 200B or from the lower unit 200B, only one six conveyance path 801f may be assigned as in the embodiment. By assigning only the sixth conveyance path 801f as a conveyance path of the upper unit 200A along which banknotes are conveyed between the upper unit 200A and the lower unit 200B, the number of openings of the safe 201 is able to be reduced and this makes it possible enhance the security of the lower unit 200B.

Next, the control unit 701 will be described. The control unit 701 controls the deposit/withdrawal opening 102, the storage cassettes 202, the discrimination unit 804, the conveyance units and the switching units 812. For example, the delivery unit (807 to 809) of the deposit/withdrawal unit 802 and the storage cassettes 202 are controller to deliver banknotes held in the deposit/withdrawal opening 102 or the storage cassettes 202; the conveying unit 811 is controlled to convey the banknotes thus delivered; the discrimination unit 804 is controlled to perform discrimination of the banknote; the switching unit is controlled to determine the conveyance direction; and the stacking unit (810, 814) of the deposit/withdrawal unit 802 or the storage cassettes 202 is controlled to store the banknotes into the deposit/withdrawal opening 102 or the storage cassettes 2027.

The control unit 701 may be provided in each of the upper unit 200A and the lower unit 200B, or alternatively the single control unit may be provided for both the upper unit 200A and the lower unit 200B.

Next, the conveyance direction control for each conveyance path will be described in brief. For example, in FIG. 8, in an ordinary transaction such as a deposit transaction, a withdrawal transaction and the like, an one-way conveyance path for conveyance of banknotes in only one direction is indicated by a single-headed arrow, and a bidirectional conveyance path for conveyance of banknotes on a single conveyance path in both directions is indicated by a double-headed arrow. The fourth conveyance path 801a, which is part of the first conveyance path (801a, b), may be the one-way conveyance path for conveyance in only one direction from the delivery unit (807 to 809) to the second switching unit 812b. The fifth conveyance path 801a which is part of the first conveyance path (801a, b), the sixth conveyance path 801f, the discrimination-unit conveyance path 804c, the second conveyance path 801d and the temporary-vault conveyance unit 801h may be bidirectional conveyance paths along which banknotes can be conveyed in both directions by switching the conveyance direction with reference to processing. Further, the third conveyance path 801e may be the one-way conveyance path for conveyance of banknotes in only one direction from the first switching unit 812a to the stacking unit (810, 814). The fourth conveyance path 801a and the third conveyance path 801e are provided as the one-way conveyance paths to achieve a simplified conveying unit, enabling a reduction in size of the machine and a reduction in jam occurrence.

Next, the deposit transaction will be described. The control unit 701 controls the deposit/withdrawal unit 802, the storage cassettes, the discrimination unit 804, the conveying units, the switching units, and the temporary storage unit 805 in order to perform a deposit transaction. In the deposit transaction (deposit counting processing), the delivery unit (807 to 809) conveys banknotes inserted into the deposit/withdrawal opening 102, one by one from the delivery slot 817 of the deposit/withdrawal opening 102 to the first conveyance path (801a, b). Then, the conveying unit of the first conveyance path (801a, b) conveys the banknote to the discrimination unit 804. Then, the discrimination unit 804 performs discrimination on the banknote conveyed thereto by the first conveyance path (801a, b). Then, the conveying unit of the second conveyance path 801d conveys the banknote subjected to the discrimination at the discrimination unit 804, to the first switching unit 812a. Then, based on the discrimination result of the discrimination unit 804, the first switching unit 812a switches the direction of banknote conveyance either to the direction toward the temporary storage unit 805 or to the direction toward the third conveyance path 801e. Then, the conveying unit of the temporary-vault conveyance path 801h conveys the banknote heading for the temporary storage unit 805, to the temporary storage unit 805, and the temporary storage unit 805 stores the banknote. The conveying unit of the third conveyance path 801e conveys the banknote heading toward the third conveyance path 801e, to the stacking unit (810, 814) of the deposit/withdrawal unit 802, and the stacking unit (810, 814) stacks the banknote into the deposit/withdrawal opening 102.

Here, the banknote conveyed into the deposit/withdrawal opening 102 is the banknote which has been determined to be a rejected banknote by the discrimination unit 804, which corresponds to a banknote that must not be kept in the banknote storage cassette 202 in the lower unit 200B (e.g., a damaged banknote, a banknote of which a denomination has been not determined, and the like), and the like. Such banknotes are returned to the user. In contrast, the banknotes conveyed into the temporary storage unit 805 include a genuine banknote of which a denomination has been determined, and a counterfeit banknote, which are able to be kept in the banknote storage cassettes in the lower unit 200B. It is noted that there may be an aspect in which, depending on the rules of each country, counterfeit banknotes are conveyed into the deposit/withdrawal opening 102.

Next, the control unit 701 performs the deposit transaction (deposit storing processing). In the deposit transaction (deposit storing processing), the temporary storage unit 805 delivers, on a one-by-one basis, the banknotes stored therein through the deposit counting processing, and the conveying unit of the temporary-unit conveyance path 801h conveys the banknote to the first switching unit 812a. The first switching unit 812a switches the direction of banknote conveyance to the direction toward the second conveyance path 801d. The conveying unit of the second conveyance path 801d conveys the banknote conveyed thereto by the first switching unit 812a, to the discrimination unit 804. The discrimination-unit conveyance path 804c of the discrimination unit 804 conveys the banknote converted thereto by the conveying unit of the second conveyance path 801d, to the fifth conveyance path 801b. The second switching unit 812b switches the conveyance direction of the banknote converted thereto by the fifth conveyance path 801b, to the direction toward the sixth conveyance path 801f. Then, based on the discrimination result of the discrimination unit 804, a lower-portion conveyance path conveys the banknote into each banknote storage cassette in the lower portion. As the discrimination result, a discrimination result of the discrimination which has been re-performed by the discrimination unit 804 in the deposit storing processing may be used, or alternatively the discrimination result obtained in the deposit counting processing may be used without performing the discrimination again. It is noted that, where a counterfeit banknote is stored in the upper storage cassette 806 in the upper unit 200A, the discrimination result obtained in the deposit counting processing may be used.

Next, the withdrawal transaction will be described. The control unit controls the deposit/withdrawal unit 802, the storage cassettes, the discrimination unit 804, the conveying units, the switching units, and the temporary storage unit 805 in order to perform a withdrawal transaction. Each of banknotes, which have been delivered one by one from the banknote storage cassette in the lower unit 200B, is conveyed to the second switching unit 812b by the conveying unit of the sixth conveyance path 801f. Then, the conveying unit of the fifth conveyance path 801b conveys the banknote conveyed to the second switching unit 812b, to the discrimination unit 804. The discrimination unit 804 performs discrimination on the banknote conveyed thereto by the fifth conveyance path 801b. Then, the banknote, which has been subject to the discrimination at the discrimination unit 804, is conveyed to the first switching unit 812a by the conveying unit of the second conveyance path 801d. Based on the result of the discrimination at the discrimination unit 804, the first switching unit 812a switches the direction of banknote conveyance either to the direction toward the temporary storage unit 805 or to the direction toward the third conveyance path 801e. The conveying unit of the temporary-vault conveyance path 801h conveys the banknote heading toward the temporary storage unit 805, to the temporary storage unit 805. The conveying unit of the third conveyance path 801e conveys the banknote heading toward the third conveyance path 801e, to the stacking unit (810, 814) of the deposit/withdrawal unit 802, and the stacking unit (810, 814) stacks the banknote into the deposit/withdrawal opening 102.

Here, the banknote conveyed into the deposit/withdrawal opening 102 is the banknote which has been determined to be a genuine banknote by the discrimination unit 804, which is a dispensable banknote. In contrast, the banknote conveyed into the temporary storage unit 805 is a dispense reject banknote which has been determined to be a rejected banknote, which corresponds to a banknote that must not be dispensed into the deposit/withdrawal opening 102 (e.g., a damaged banknote, a banknote of which a denomination has been not determined, and the like), and the like.

The present invention, which has been described, is not limited to the above-described embodiment, and may have at least any of the following features.

A feature has that the first conveyance path has the first conveying roller changing the conveyance direction of a banknote conveyed from the delivery unit, from the downward direction to the lateral direction, and the first conveying roller comes into contact with the banknote at the time when the delivery unit is in contact with the banknote in question. The first conveying roller fulfills two roles of the role to receive a banknote conveyed from the deposit/withdrawal unit and the role to change the conveyance direction, thereby enabling a simplification of the conveying mechanism below the delivery unit and a reduction in the height from the ground of the deposit/withdrawal opening (particularly, the height from the ground in the front). In particular, conventionally, a reduction of the height from the ground of the deposit/withdrawal unit is difficult due to the second switching unit, the foreign-substance storage space, the conveying belt, the discrimination unit and/or the like. In the banknote handling device according to the embodiment, however, an effective use of the space between the bottom surface of the deposit/withdrawal unit and the bottom surface (referred to as the “lower surface” or “bottom plate”) of the upper unit is possible.

Further, a feature is that the fifth conveyance path is sloped in a direction that the discrimination-unit end of the fifth conveyance path is located at a higher level than (upward of) the sixth-conveyance-path end of the fifth conveyance path. This enables ensuring the space below the deposit/withdrawal unit, so that the stacking unit is able to be placed in the front or in a downward portion. This makes it possible to reduce the height from the ground of the display input unit which is located above the deposit/withdrawal opening.

Further, a feature is that the second conveying roller is placed below the fifth conveyance path and the first conveying roller is placed above the conveyance path that extends in a lateral direction of the fourth conveyance path. The space between the deposit/withdrawal unit and the bottom surface of the upper unit is able to be effectively sued.

Further, a feature is that the third conveying roller, which comes into contact with a banknote at the time when the discrimination-unit conveying unit is in contact with the banknote in question, is possessed, and the third conveying roller is placed below the fifth conveying path. The third conveying roller is not placed above the fifth conveyance path, thereby enabling the stacking unit being placed in a downward portion.

Further, a feature that is the bottom surface of the deposit/withdrawal unit is situated below the upper surface of the discrimination unit. A reduction of the height from the ground of the deposit/withdrawal unit is made possible.

Further, a feature is that the discrimination unit is tilted in a direction that the fifth-conveyance-path side of the discrimination unit is situated at a lower level than the second-conveyance-path side of the discrimination unit. A reduction of the height from the ground of the stacking-unit end is made possible.

Further, a feature is that: the rail unit possessed by the upper enclosure has the slider portions that are secured to the both side surfaces of the banknote handling device and slide out/into in the front-rear directions, and the stationary portions that are secured to the upper enclosure and allow the slider portions on the both side surfaces to slide out/into thereon; and the first medium handling device (e.g., the receipt issuing device) is secured to a first side surface which is any one of both the side surfaces of the banknote handling device, and by sliding the banknote handling device into/out in the front-rear directions, the first medium handling device also moves in the front-rear directions. This enables a reduction in size in the width direction of the automatic teller machine, resulting in a reduction in size of the automatic teller machine.

Further, a feature is that the rail unit is sloped such that a front end of the rail unit is situated at a higher level than a rear end of the rail unit. When the banknote handling device and the first medium handling device are pulled forward out along the single rail, even if the slider portion is weighted downward with the weight of both the banknote handling device and the first medium handling device, doing a job in the lower enclosure is made possible.

Further, a feature is that the enclosure has the auxiliary member secured to the enclosure to support the first medium handling device upward from below the first medium handling device, and the auxiliary member is a roller that rotates in contact when the first medium handling device moves in the front-rear direction. This makes it possible to restrict the width direction of the automatic teller machine and also to inhibit the weighting down of the first medium handling device.

Further, a feature is that the deposit/withdrawal opening of the upper unit and the receipt handling slot from which a receipt which is a medium of the first medium handling device is issued are approximately at the same height, and the card handling slot of the card handling device accepting a card, and the receipt handling slot are placed to overlap each other in the vertical direction. This makes it possible to place the operation unit of the automatic teller machine in a position providing ease of operation for users (within a predetermined height from the ground, within a predetermined breadth, and within a predetermined distance from the front of the machine).

According to the foregoing present invention, a size reduction of the banknote handling device or the automatic teller machine is made possible. Further, the maintenance of usability for a wide variety of users is made possible. As a result, it is possible to meet Americans with Disabilities Act (hereinafter referred to as “ADA standards”) which was established with the objective of prohibiting discrimination against individuals with disabilities and offering equal opportunities to all individuals with disabilities and abilities. For example, a section pertaining to machine operation is able to be placed within a height of 1220 mm from the floor and the operation unit used by end users is able to be placed within a 255 mm from the front of the machine.

### REFERENCE SIGNS LIST

100: ATM,
100A: Upper enclosure,
100B: Lower enclosure,
101: Display input unit,
102: Deposit/withdrawal opening,
103: Card handling slot,
104: PIN pad,
105: Receipt handling slot,
106: Function key,
108: Front end of the display input unit,
200A: Upper unit of a banknote handling device,
200B: Lower unit of the banknote handling device,
201: Safe,
202: Storage cassette,
203: Transfer unit,
204A: Machine front side (front),
204B: Machine rear side,
301: Card handling device,
401: Auxiliary roller,
501: Receipt issuing device,
502: Mount plate,
503: Panel,
504: Door,
510: Rail,
510A: Slider portion,
510B: Stationary portion,
601: Main control unit,
603: External storage device,
604: Power source,
701: Control unit,
801: Conveyance path,
802: Deposit/withdrawal unit,
803: Shutter,
804: Discrimination unit,
805: Temporary vault,
806: Upper storage cassette,
807: Pickup roller,
808: Feed roller,
809: Gate roller,
810: Stacking unit,
811: Conveying unit,
812: Switching unit,
814: Stacking unit (vane roller),
815: Pressing plate,
816: Stacking slot,
817: Delivery slot,
820: Driven component.

1. An automatic teller machine having a banknote handling device that handles banknotes,
wherein the banknote handling device has:
a deposit/withdrawal opening for receiving insertion of banknotes from a user or for supplying banknotes to the user;
a deposit/withdrawal unit having a delivery unit that delivers banknotes one by one from the deposit/withdrawal opening, and a stacking unit that stacks banknotes one by one into the deposit/withdrawal opening;
a first conveyance path along which a banknote is conveyed between the delivery unit and a discrimination unit that performance discrimination on a banknote;
a second conveyance path along which a banknote is conveyed between the discrimination unit and a first switching unit that switches a direction of banknote conveyance between a direction toward a temporary storage unit that stores temporarily banknotes and a direction toward the stacking unit;
a third conveyance path along which a banknote is conveyed between the first switching unit and the stacking unit; and
a first conveying roller that forms part of the first conveyance path and changes a conveyance direction of a banknote conveyed from the delivery unit, from a downward direction to a lateral direction at an acute angle, wherein the first conveying roller comes into contact with a banknote at the time when the delivery unit is in contact with the banknote.

2. The automatic teller machine according to claim 1,
wherein the banknote handling device has:
a lower unit that includes a storage cassette in which banknotes are stored;
a sixth conveyance path along which a banknote is conveyed into the lower unit from between the first conveying roller and the discrimination unit; and
a fifth conveyance path located within the first conveyance path, the fifth conveyance path along which a banknote is conveyed in a lateral direction between the discrimination unit and the sixth conveyance path,
the fifth conveyance path being sloped in a direction that its end closer to the discrimination unit is located at a higher level than its end closer to the sixth conveyance path.

3. The automatic teller machine according to claim 2, comprising:
a fourth conveyance path along which a banknote is conveyed in a lateral direction between the first conveying roller and the fifth conveyance path; and
a second conveying roller that forms part of the fifth conveyance path and part of the sixth conveyance path,
wherein
the first conveying roller is situated above the fourth conveyance path, and
the second conveying roller is situated below the fifth conveyance path.

4. The automatic teller machine according to claim 3, comprising
a third conveying roller that comes into contact with a banknote at the time when a discrimination-unit conveying unit, which conveys a banknote within the discrimination unit, is in contact with the banknote,
wherein the third conveying roller is situated below the fifth conveyance path.

5. The automatic teller machine according to claim 1,
wherein the deposit/withdrawal unit has a bottom surface situated below an upper surface of the discrimination unit.

6. The automatic teller machine according to claim 1,
wherein the discrimination unit is tilted in a direction that a fifth-conveyance-path side of the discrimination unit is located at a lower level than a second-conveyance-path side of the discrimination unit.

7. The automatic teller machine according to claim 1, comprising:
an upper enclosure that incorporates an upper unit which is a unit of an upper portion of the banknote handling device and a first medium handling device different from the banknote handling device; and
a rail unit that moves the upper unit relative to the upper enclosure in front-rear directions,
wherein
the rail unit has:
a slider portion that is secured to both side surfaces of the banknote handling device and slides out/into in the front-rear directions; and
a stationary portion that is secured to the upper enclosure and allows the slider portion on the both side surfaces to slide out/into thereon, and
the first medium handling device is secured to a first side surface which is any one of the both side surfaces of the banknote handling device, and as the banknote handling device is slid into/out in the front-rear directions, the first medium handling device also moves in the front-rear directions.

8. The automatic teller machine according to claim 7,
wherein the rail unit is sloped such that a front end of the rail unit is situated in a higher position than a rear end of the rail unit.

9. The automatic teller machine according to claim 7,
wherein the enclosure has an auxiliary member that is secured to the enclosure to support the first medium handling device upward from below the first medium handling device, and the auxiliary member is a roller that rotates in contact when the first medium handling device moves in the front-rear direction.

10. The automatic teller machine according to claim 7, comprising:
a card handling device that is placed below the first medium handling device and alongside the upper unit for reading of information on a card; and
a PIN pad that is placed in the front of the upper unit for reception of entry of a personal identification number from a user,
wherein
the deposit/withdrawal opening of the upper unit and a receipt handling slot from which a receipt which is a medium of the first medium handling device is issued are approximately at the same height, and
a card handling slot of the card handling device for receiving a card, the receipt handling slot are placed to overlap each other in a vertical direction.

11. A banknote handling device handling banknotes, comprising:
a deposit/withdrawal unit that has a deposit/withdrawal opening in which banknotes are received from a user, and a delivery unit which delivers banknotes in the deposit opening on a one-by-one basis; and
a first conveying roller that changes a direction of banknote conveyance between a conveyance path along which a banknote is conveyed from the delivery unit along a vertical direction and a conveyance path along which a banknote is conveyed along a horizontal direction,
wherein a distance between the delivery unit and the first conveying roller is shorter than a length of a banknote in the direction of conveyance.

12. The banknote teller device according to claim 11, comprising:
a lower unit having a storage cassette for storing banknotes;
a fourth conveyance path that has a conveyance path along which a banknote is conveyed from the delivery unit along the vertical direction, a conveyance path along with a banknote is conveyed along the horizontal direction, and the first conveying roller;
a fifth conveyance path along which a banknote is conveyed in a lateral direction between the fourth conveyance path and a discrimination unit which performs discrimination on a banknote; and
a sixth conveyance path along which a banknote is conveyed from the fifth conveyance path to the lower unit,
wherein
the fifth conveyance path is sloped in a direction that a sixth-conveyance-path end of the fifth conveyance path is situated at a lower level than a discrimination-unit end of the fifth conveyance path.

13. The banknote handling device according to claim 12, comprising:
a discrimination-unit conveying unit that conveys a banknote within the discrimination unit; and
a third conveying roller that forms part of the fifth conveyance path and that is placed in a position where a distance between the third conveying roller and the discrimination-unit conveying unit is shorter than a length of a banknote in the direction of conveyance,
wherein the third conveyance roller is situated below the fifth conveyance path.
